(19) United States
(12) Patent Application Publication
(10) Pub. No.: US 2015/0083084 A1
(43) Pub. Date: Mar. 26, 2015

(54) FRICTION REDUCTION AND VARIABLE COMPRESSION RATIO

(71) Applicant: BEHNAM NEDAIE, Kitchener (CA)

(72) Inventor: BEHNAM NEDAIE, Kitchener (CA)

(21) Appl. No.: 14/492,985

(22) Filed: Sep. 22, 2014

Related U.S. Application Data
(60) Provisional application No. 61/881,429, filed on Sep. 23, 2013.

(51) Int. Cl. F02B 75/04; F02B 75/32

(52) U.S. Cl. CPC F02B 75/045; F02B 75/32
USPC 123/48 B; 123/197.4

(57) ABSTRACT

Apparatus for increasing internal combustion engine efficiency by substantial reduction of the friction between piston and cylinder by using a piston rod with one degree of freedom and said degree of freedom being translational motion along the central axis of the cylinder and supporting the said piston rod by stationary roller/ball bearings or by non-stationary moving cylindrical rollers. Additionally enhancing the combustion by introducing an insert into head cylinder and controlling the volume of the cylinder chamber when the piston is at top dead center at the end of compression stroke; thus controlling the compression ratio of the engine by the position of the said insert.

### BACKGROUND OF THE INVENTION

1. Field of Invention

Internal Combustion engines have been in use for over one hundred years. In the case of common gas and diesel engines, it is known that between 20-25% of fuel power is lost due to the friction force between the piston and the cylinder; this is particularly more evident while the engine is under significant mechanical load. The share of loss due to friction between the piston rings and the cylinder is approximately 3% of fuel power. The reason for the high loss of power due to friction between the piston and the cylinder is the large force which acts on the piston rod. That force has a component perpendicular to cylinder inside wall. Although there are other frictional losses in internal combustion engines, but the said friction between the piston and cylinder is the major frictional loss. Reduction of said friction force will cause greater efficiencies than that of normal engines.

On the combustion side, for enhancing the engine performance and efficiency, the ability to change the compression ratio, although not a vitality, has received more attention in recent years.

As far as enhancement of combustion and engine efficiency is concerned, this disclosure will be addressing these two concepts.

### OBJECTIVE OF THE INVENTION

The principal objective of this invention is to introduce a new method of drastically reducing the friction force between the piston and the cylinder. In that regard the invention will introduce support mechanisms for piston rods with one degree of freedom and will expand on the concept of piston rod support for the piston rods and crank cams which are introduced in “Behnam Reciprocating Mechanisms”, B. Nedaie, U.S. pending patent application Ser. No. 13/482,993. Furthermore this disclosure shows how the same principle could be applied for piston rods connecting to ordinary crankshafts. For a piston rod with only translational motion, a special connection between the piston and piston rod will be illustrated. In addition to that in order to enhance combustion, a method of changing the compression ratio will be presented.

### LIST OF FIGURES

The disclosure shall be presented by the aid of the following figures:

FIG. 1 shows a geometrical presentation of piston rod from “Behnam Reciprocating Mechanisms” supported with roller bearings.

FIG. 1a shows a three dimensional model of the apparatus said in FIG. 1.

FIG. 2 shows a geometrical presentation of a piston rod for an ordinary crankshaft being supported with roller bearings.

FIG. 2a shows a three dimensional model of the apparatus said in FIG. 2.

FIG. 2b shows the geometrical-conceptual illustration of an apparatus for a piston rod being supported by moving cylindrical rollers while the piston is at top dead center position.

FIG. 2c shows the apparatus said in FIG. 2b after the movement of the piston to bottom dead center position.

FIG. 2d shows the isometric view of an apparatus for supporting the piston rod with moving rollers in which the piston rod and the moving rollers are furnished with gear teeth.

FIG. 2e shows the apparatus said in FIG. 2d disassembled.

FIG. 2f shows section A-A from FIG. 2d (only the portion of the section is shown which holds geared rollers,).

FIG. 2g shows section A-A shown said in FIG. 2f in isometric view.

FIG. 2h shows front elevation view of the apparatus said in FIG. 2d.

FIG. 2j shows section B-B shown from FIG. 2h.

FIG. 2i shows section B-B shown in FIG. 2j in isometric view.

FIG. 3 shows the top dead center position at the end of compression stroke for an engine with a certain compression ratio.

FIG. 4 shows the apparatus said in FIG. 3 with compression ratio insert substantially moved into the cylinder to decrease top dead center volume and as a result creating higher compression ratio than that of shown for apparatus in FIG. 3.

FIG. 5 shows the option of having the piston and the piston rod as one solid piece.

FIG. 6 shows the option of having the piston and the piston rod as two separate pieces.

FIG. 7a shows an apparatus for special connection of piston and piston rod such that the piston can have minute movements with respect to the piston rod in any direction perpendicular to the piston central axis.

FIG. 7b shows the point of connection of piston and piston rod said in FIG. 7a from a different angle enlarged by a scale factor of 2.

FIG. 7c shows section C-C from FIG. 7a enlarged with scale factor of 2 (only the portion which shows the connection of the piston to piston rod is shown).

FIG. 7d shows the apparatus said in FIG. 7a disassembled.

### DESCRIPTION OF THE INVENTION

Drastic reduction of friction force between the cylinder and the piston:

Considering an ordinary internal combustion engine, as said before the loss of power due to friction between the piston and the cylinder accounts for a large portion of power produced by the fuel. In engines with ordinary crankshafts, the said friction force is directly proportional to the coefficient of friction between the cylinder and the piston, and the normal component of the force (normal to cylinder wall) by which the piston and the piston rod exert against each other. This is because the same force will be exerted by the piston to the cylinder. The said friction force is variable throughout the duration of each stroke mainly because the pressure inside the cylinder chamber changes during a stroke; additionally the piston rod has two degrees of freedom: translation and rotation. Due to the said rotation the magnitude of the said friction force changes as the angle of piston rod with respect to piston central axis changes.

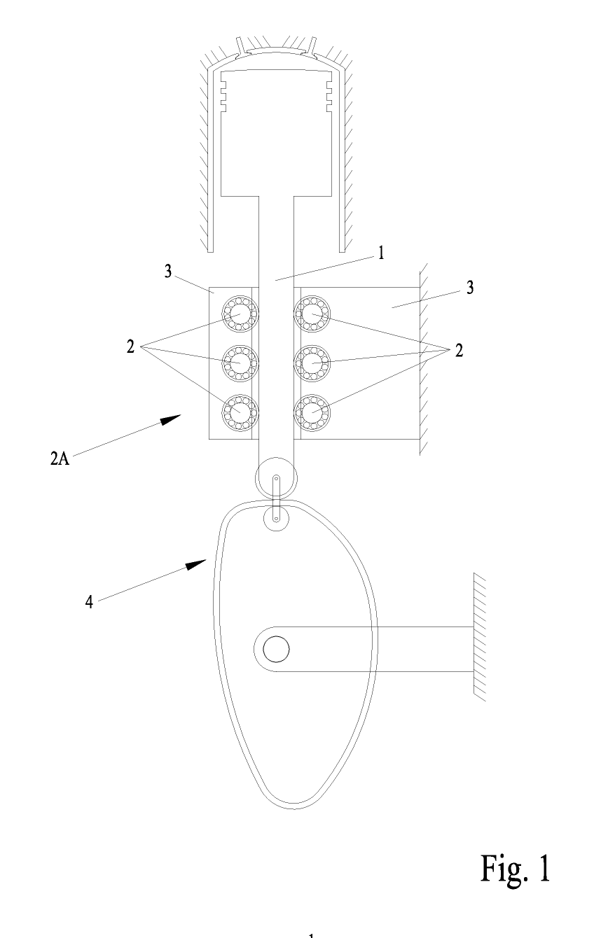

For a cam engine which has a piston rod with one degree of motion and in particular an engine with a crank cam suggested in “Behnam Reciprocating Mechanisms”, (U.S. pending patent Ser. No. 13/482,993 by B. Nedaie), the piston rod which is directly connected to the piston, has only one degree of freedom and that degree of freedom is translation along the cylinder's central axis. As a result if the piston rod is supported by roller bearings, the friction force between piston and cylinder will be almost eliminated. The two FIGS. 1 & 1a show the basic geometrical presentation and a three dimensional model of the concept for said Behnam crank cam 4 respectively (the cylinder, piston and valves are not numbered).

The piston rod 1 (the piston and piston rod could be one solid piece) is supported by roller bearings 2 which are held by the stationary support 3; the assembly of the stationary support 3 and the roller bearings 2 (in this case 6 roller bearings) is shown by numeral 2A (numeral 2A is shown in a simple presentation to illustrate the concept). Said numeral 2A is fixed to the engine block (engine block not shown); also the crankshaft's central shaft is mounted as normally a crankshaft is held in the engine block. The piston rod 1 must have flat surfaces where it is in contact with the roller bearings 2. As a result of the geometry of this apparatus, the piston does not exert a significant force against the cylinder and the said force will be reduced drastically. The number of roller bearings on either side of piston rod 1 must be at least two. In the apparatus shown in FIGS. 1 & 1a there are three roller bearings 2 on either side of piston rod 1.

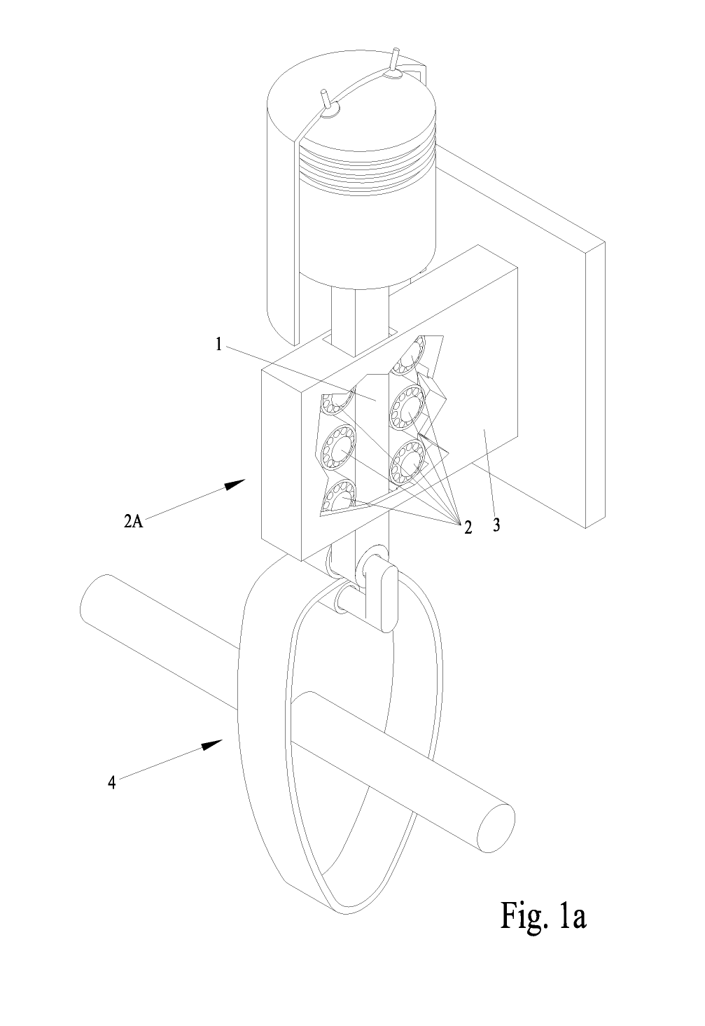

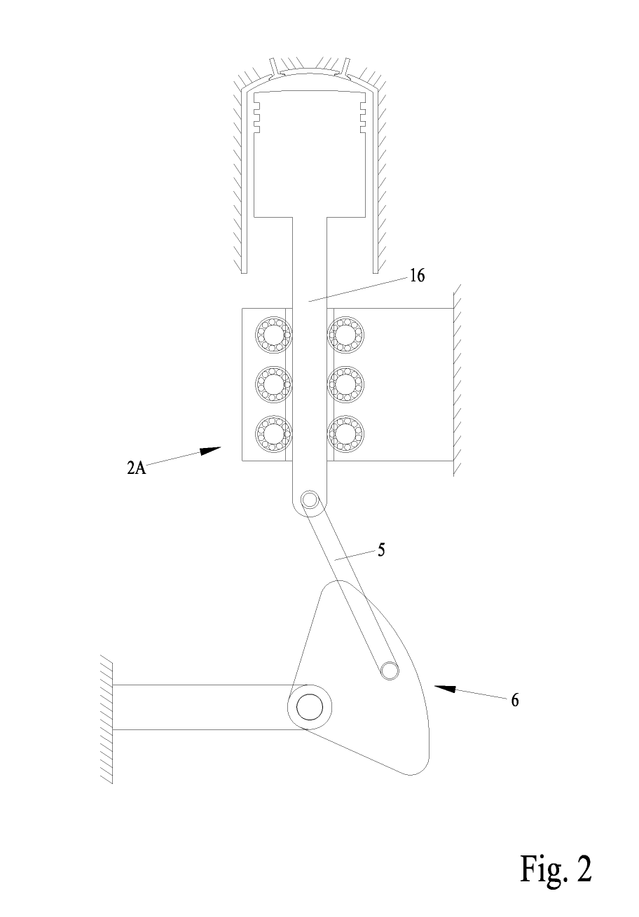

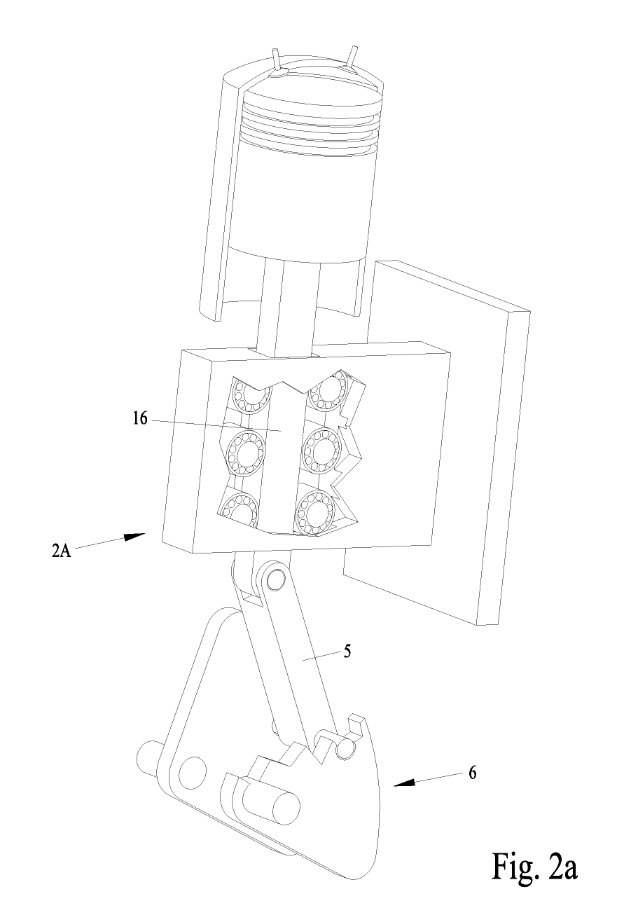

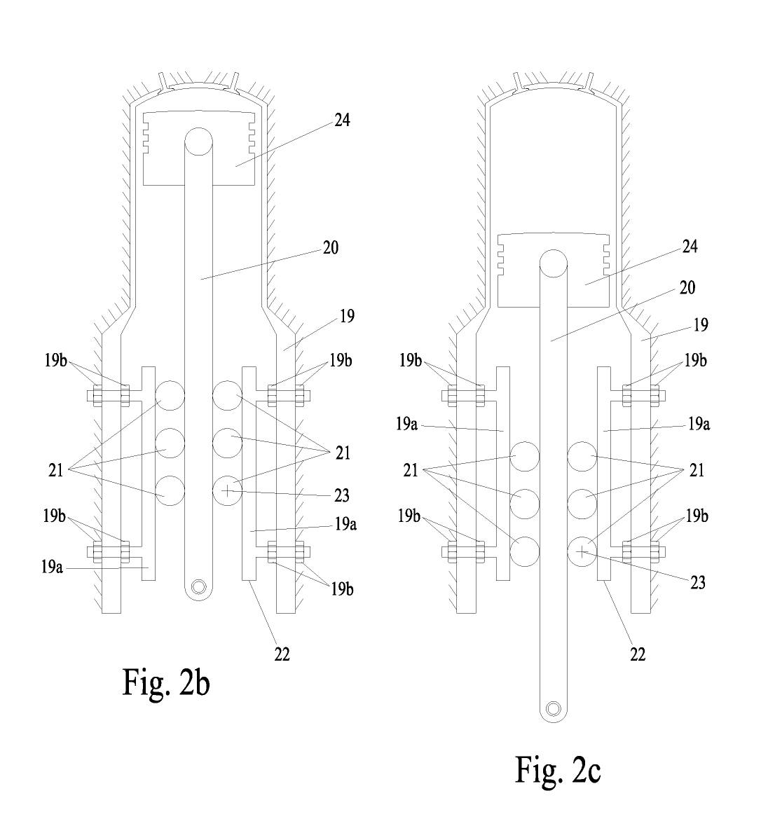

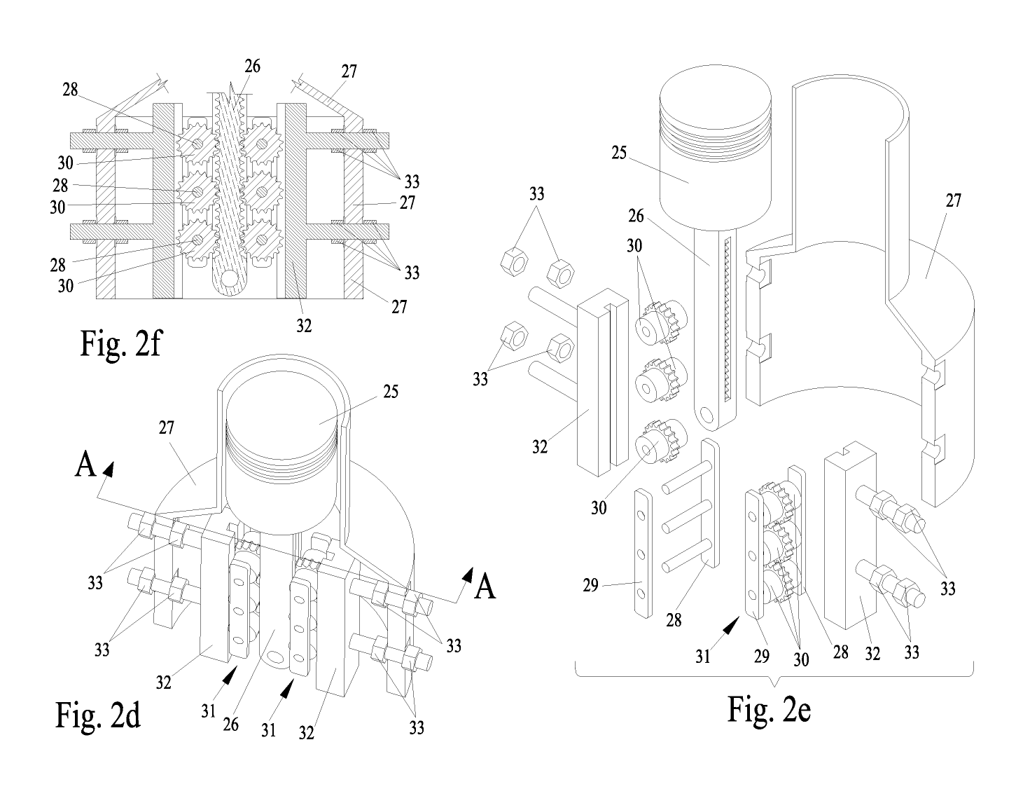

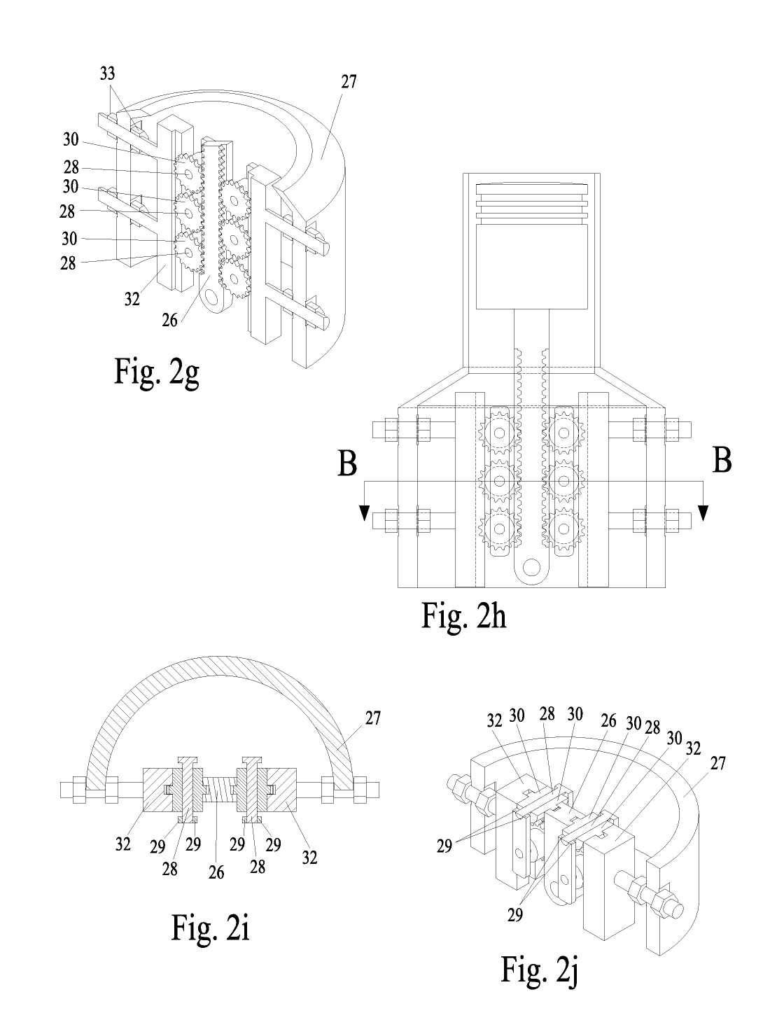

Referring to FIGS. 2 & 2a, likewise the same concept could be applied to ordinary crankshafts by having a connection link 5 Numeral 6 is an ordinary crankshaft which is connected to piston rod 16 by connection link 5. In this apparatus the friction force between the piston and the cylinder will be also reduced drastically because of similar reasons mentioned for apparatus presented in FIGS. 1 & 1a. It is understood that connection link 5 has two degrees of freedom where the piston rod 16 has only one degree of freedom; that degree of freedom is translation along the piston central axis.

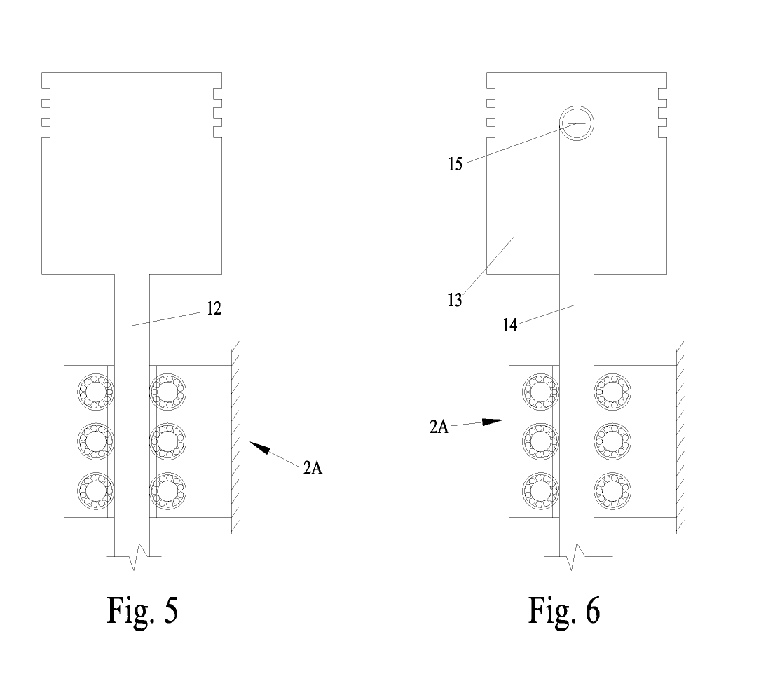

For both apparatuses shown in FIGS. 1a & 2a the piston rod and the piston can be a solid piece together or be separated and connected to each other as they normally are with a pivot point at the point of contact of piston and the piston rod. However in both cases the rod which is connected to the piston has only one degree of freedom. FIGS. 5 & 6 show the two different scenarios. In FIG. 5 the piston and the piston rod are one solid piece and shown by numeral 12 (the cylinder and the crankshaft not shown), said piston rod 12 is supported by numeral 2A. In FIG. 6 the connection of a piston and piston rod is shown (the cylinder and the crankshaft not shown). The piston 13 and piston rod 14 are two separate parts and are connected at point 15. Said piston rod 14 is supported by piston rod support assembly 2A. Both piston rods 12 and 14 in FIGS. 5 & 6 have only one degree of freedom and that is translation along the central axis of the piston.

The same result might be achieved with other similar arrangements. For example for each roller bearing, two ball bearings holding a roller could be used. Another scenario is supporting the piston rod from two directions instead of one direction as shown in this disclosure. But in mechanisms shown in FIGS. 2 & 2a and other similar configurations the central axis of each of the roller or ball bearings is stationary. That is the said central axes have no movement with respect to engine block.

Since the forces acting on the stationary ball or roller bearings supporting the piston rod mentioned so far will be tremendous, particularly when the engine is under great mechanical load at high RPM, therefore as a result the size of these bearings might be so large that it might not be practical to implement stationary roller or ball bearings in practice. Therefore it is important to consider the option of supporting the piston rod with moving cylindrical rollers. FIGS. 2b to 2j (9 figures) show the drawings associated with this concept. FIGS. 2b and 2c show the basic geometrical concept of moving rollers and FIGS. 2d to 2j are associated with the moving rollers furnished with gear teeth.

In FIGS. 2b & 2c (2 figures) the basic geometrical illustration of the concept of moving rollers with two different positions of the piston are illustrated. In FIG. 2b, inside the engine block 19, the piston 24 is connected to the piston rod 20 and the said piston rod 20 is supported by quantity of 6 moving cylindrical rollers 21; the cylindrical moving rollers 21 are held tight between the piston rod 20 and stationary support 19a; nuts 19b allow adjusting and fastening the stationary support 19a to the engine block 19. On either sides of the piston rod 20, there are 3 moving cylindrical rollers 21. The moving cylindrical rollers 21 are in close contact with the piston rod 20 and the stationary support 19a. As mentioned before for the case of stationary roller bearings, in this case as well, a minimum of 2 moving cylindrical rollers 21 are needed on either sides of piston rod 20. In FIG. 2b the position of the piston 24 is at top dead center position. In FIG. 2c the same apparatus is shown as in FIG. 2b except the piston 24 and piston rod 20 have moved to bottom dead center position. In both FIGS. 2b & 2c the center of one of the moving cylindrical rollers 21 is shown by numeral 23 and an edge from the stationary support 19a is shown by numeral 22 for reference datum. By comparing the two FIGS. 2b & 2c, it is clear that as the piston rod 20 has moved form top dead center to bottom dead center position, the center point shown by numeral 23 has changed its position with respect to edge 22. Another word as the piston rod 20 moves cylindrical rollers 21 roll in the same direction and the central axis of the each of the moving cylindrical rollers 21 translated in the same direction.

In order to use moving cylindrical rollers 21 for the purpose of supporting the piston rod 20, it must be realized that first of all the central axes of rotation of these moving rollers 21 must have no motion with respect to each other. That is during the operation of the engine the distance between each two rollers must remain the same at all times. Secondly there must be no slippage at the area of contact between the surfaces of the moving cylindrical roller 21 and the piston rod 20 and the stationary support 19a. Such slippages can severe the operation of the engine and additionally may result in frictional losses.

In order to address the said two points in the previous paragraph, each of the moving cylindrical rollers and the piston rod could be furnished with gear teeth. FIGS. 2d to 2j (7 figures) are associated with this concept. In FIG. 2d an apparatus is shown in isometric view for supporting the piston rod with moving rollers in which the piston rod and the moving rollers are furnished with gear teeth; in this figure half of engine block is removed to have inside mechanism visible. In FIG. 2e the same apparatus is shown in disassembled mode. FIG. 2f shows section A-A from FIG. 2d which is through the center of the piston rod and the center of the geared rollers. FIG. 2g shows the isometric view of the same section A-A said in FIG. 2f. In FIG. 2h the front elevation view of the apparatus in FIG. 2d is shown. FIG. 2i is the section B-B from FIG. 2h and FIG. 2j is the same section shown in FIG. 2i in isometric view.

The components and their function are as follows:

Piston 25: Piston 25 is inside the cylinder of engine block 27 and is connected to piston rod 26; the piston 25 and the piston rod 26 could be two separate pieces or one solid piece. Piston 25 has one degree of motion and that is translation along the central axis of the corresponding cylinder in engine block 27.

Piston rod 26: Piston rod 26 has only one degree of motion and that is translation along the central axis of the corresponding cylinder; unlike ordinary piston rods, it does not have any rotational motion. It is connected to piston 25 from one end and from the opposite end is connected to either a cam shaft as already shown in FIGS. 1 & 1a, or is connected by a link to an ordinary crankshaft as was shown in FIGS. 2 & 2a. The cross-section of piston rod 26 is preferably rectangular and as shown has geared racks on two opposite surfaces which accommodate the gear teeth from the geared rollers 30. Additionally on either side of its geared portion, it has a flat surface to have contact with the cylindrical surfaces of the rollers 30. The large force exerted by the piston rod 26 to geared roller 30 is transferred by the said flat section of the piston rod 26 and not the geared portion. The purpose of the gear rack of the piston rod 26 is just to avoid slippage between the surfaces of the geared rollers 30, piston rod 26 and stationary support 32.

Engine block 27: Engine block 27 is shown only partially in a simple way to address the features discussed in this invention; the stationary support 32 is fastened to the engine block 27 by nuts 33.

Triple pin 28: Triple pin 28 has three pins and each pin goes inside the hole of geared roller 30 such that the corresponding geared roller 30 is free to rotate about the central axis of the said pin. Triple pin 28 has one degree of freedom and that motion is translation along the direction of the central axis of the cylinder.

Flat end 29: The purpose of Flat end 29 is to secure geared rollers 30 and stop the geared rollers 30 from any translation motion along the direction of its axis of rotation. Flat end 29 has one degree of freedom and that motion is translation along the direction of the central axis of the cylinder.

Geared roller 30: The geared roller 30 has a hole along its central axis and is freely rotatable about its central axis and each geared roller 30 is freely rotating about of the pins of triple pin 28. It has a gear section at the center and two cylindrical surfaces on either side of the said geared section. The large force exerted by the piston rod 26 to geared roller 30 is transferred via this cylindrical section (and not the geared portion) of the geared roller 30 to the stationary support 32.

Geared roller assembly 31: The geared roller assembly is comprised of three geared rollers 30, a triple pin 28 and a flat end 29. However the minimum number of geared rollers needed for each assembly 31 is two geared roller 30. Each pin of the triple pin 28 holds one geared roller 30 and the said geared roller 30 is free to rotate about the central axis of the corresponding pin of the said triple pin 28. The flat end 29 secures the geared rollers 30 in place. In FIG. 2e one geared roller assembly 31 is shown in assembled mode and numbered as numeral 31 and the second geared roller assembly 31 is shown in disassembled mode and every individual component is numbered.

Stationary support 32: the stationary support 32 is fastened to the engine block 27 by nuts 33 and has no motion with respect to engine block 27. Although in these illustrations the stationary support 32 is not furnished with gear teeth, however it is possible to do so.

Nuts 33: These nuts 33 allow adjustable fastening of Stationary support 32 to the engine block 27.

For all the mechanisms discussed so far, it must be noted that the illustrated piston rod support will have no or very little effect on the friction between the piston rings (rings are not shown in any of the figures) and the cylinder. That portion of friction loss due to friction between the piston rings and the cylinder may remain the same.

It is obvious that the concept for supporting the piston rod for reduction of the friction force between the piston and the cylinder will result in smaller than normal cooling system for cooling the engine block. That is the size of radiator and cooling system will be reduced drastically to the extent that in some cases only air cooling may suffice. This is because the major reason for an engine block to heat up is the contribution of the said friction force between the piston and cylinder and not the heat transfer from the combustion. Likewise because of drastic reduction of the friction between the piston and the cylinder, the size of the starter mechanism and the power required to start the engine will reduce considerably.

Special Connection of Piston to Piston Rod:

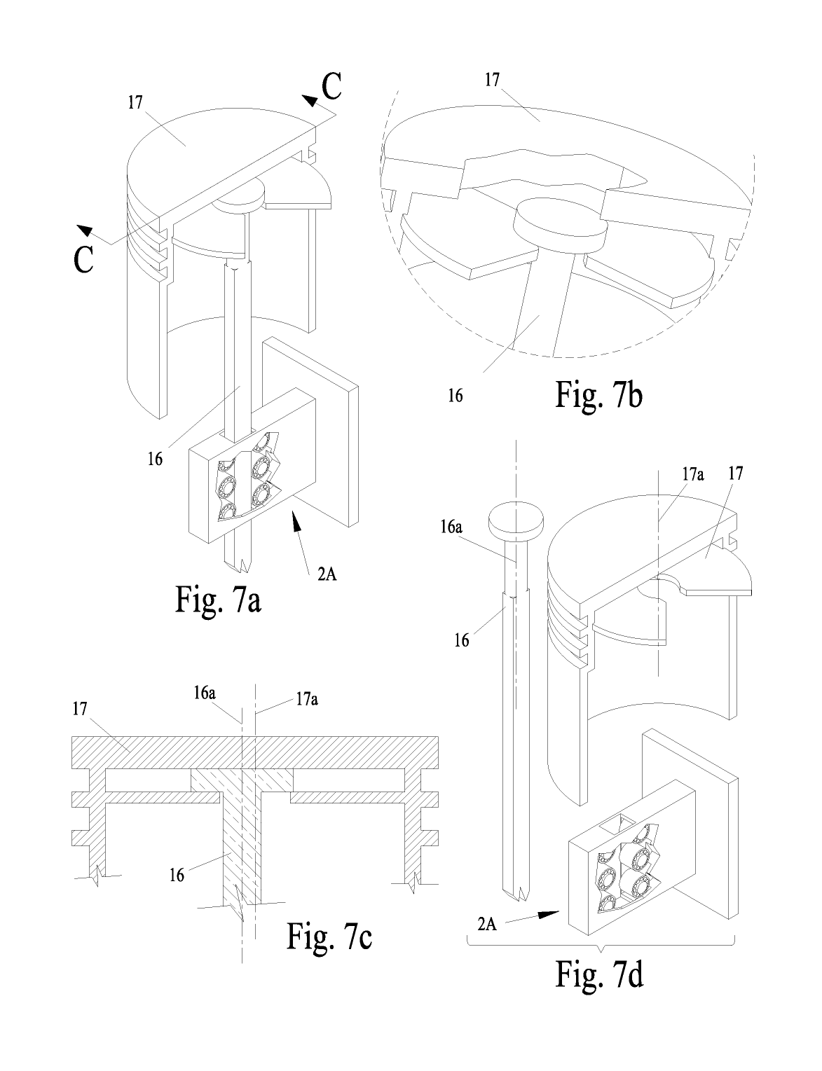

Due to the nature of the operation of a piston rod with only one degree of freedom (that degree of freedom being translation along the direction of pistons central axis), there might be a need for a special connection between the piston and the piston rod. In that regard reference will be made to FIGS. 7a, 7b, 7c and 7d (4 figures). They show an apparatus for a special connection between the piston and the piston rod, where the piston rod has only one degree of motion. In FIG. 7a the isometric view of an apparatus is shown with a piston rod which has one degree of motion and that motion is translation along the central axis of the cylinder; the apparatus provides a special connection between the piston and the piston rod such that the piston can have minute movements with respect to the piston rod in any direction perpendicular to the central axis of the piston. FIG. 7b shows a different isometric view of only the connection between the piston 17 and piston rod 16, enlarged by a scale factor of 2. FIG. 7c shows the upper portion of section C-C from FIG. 7a enlarged by a scale factor of 2. FIG. 7d shows the apparatus in FIG. 7a in disassembled mode.

Ideally there are three center lines which must be aligned. One is the central axis of the cylinder (the cylinder is not shown in these four figures); the second is the central axis of the piston 17 (numeral 17a) and the third is the centerline of the piston rod 16 (numeral 16a). In FIGS. 7c and 7d the central axes piston 17 and piston rod 16 are shown). The centerline of the piston rod will be at the middle of the two sets of the roller bearings 2 which are parts of the piston rod support which was already referred to as numeral 2A. Since the alignment of said central axes might be difficult due to manufacturing defects, other methods of connection of the piston and the piston rod might be needed in order to allow minute misalignments between the center line of the piston 17 (numeral 17a) and the central axis of the piston rod 16 (numeral 16a). That is basically allowing the piston 17 to have minute movements with respect to the piston rod 16 in any direction perpendicular to its central axis (numeral 17a).

This is because in the case of a piston rod with one degree of motion, if the connection of the piston to piston rod is a normal connection as it is in ordinary engines, manufacturing defects may cause large forces acting on the piston in the direction perpendicular to the piston axis and force the piston against the cylinder wall. In fact it was one of the main intentions of the invention to eliminate the force which the piston exerts to the cylinder. It is important that the piston must move in the cylinder as freely as possible in order to eliminate the associated frictional force.

In FIG. 7c the section C-C is shown; the eccentricity between the center line of piston rod 16 (numeral 16a) and the central axis of piston 17 (numeral 17a) is clearly shown. Since piston rod 16 is held firm by roller bearing support 2A, the piston 17's central axis shown by numeral 17a can have slight misalignments with that of piston rod 16's centerline which is shown by numeral 16a. This is due to the nature of the connection of piston rod 16 and piston 17. While piston 17 can not have any motion with respect to piston rod 16 in the direction parallel to central axis of the piston 17 (that central axis is numeral 17a), said piston 17 can have small movements with respect to piston rod 16 in any direction perpendicular to the central axis of the piston 17 (that central 17a).

Variable Compression Ratio:

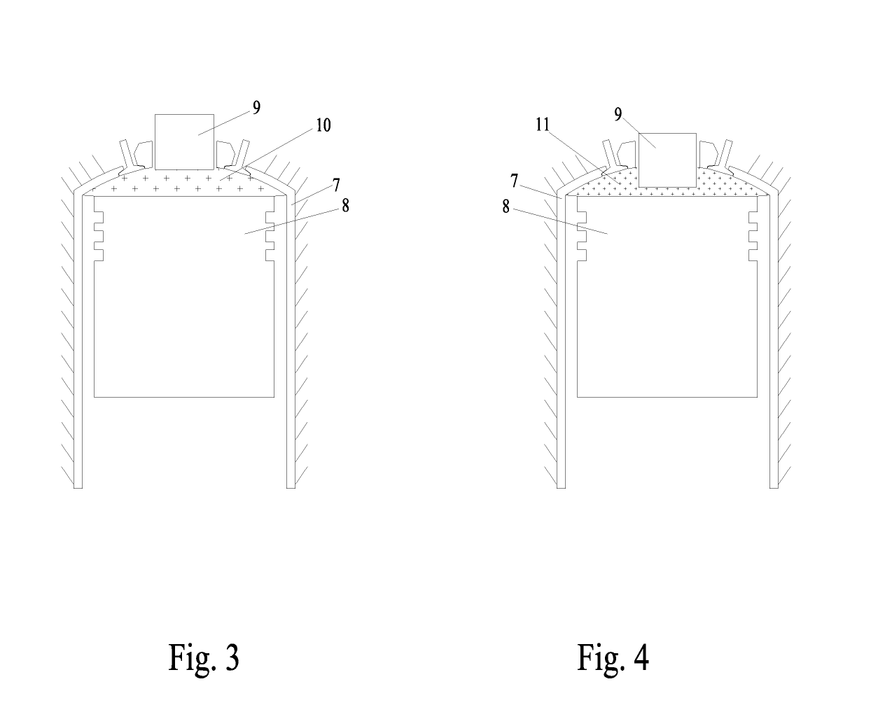

This disclosure suggests that in order to change the compression ratio for a given internal combustion engine, an insert could be pushed into or pulled out of the cylinder head in order to control the compression ratio. FIGS. 3 & 4 are associated with this concept. The compression ratio will increase as the insert is pushed into the cylinder upper chamber (head cylinder). The vice versa is also true; that is as the insert is pulled out of the head cylinder the compression ratio decreases. The gaps between parts in these figures have been exaggerated in order to distinguish the parts in said two figures.

In FIG. 3 a typical piston 8 is shown inside cylinder 7 (the cylinder and the cylinder head are shown as one piece) at top dead center position at the end of compression stroke. The certain amount of volume between the piston 8 and the cylinder 7's head, corresponds to the volume of the compressed air fuel mixture under compression at the top dead center position. The said volume is shown by numeral 10 (numeral 10 is the hatched area between cylinder head and the piston). Notice that the compression ratio insert 9 is substantially away from piston 8's top surface.

FIG. 4 shows the same apparatus as in FIG. 3 at the same top dead center position except the compression ratio insert 9 is substantially moved into the cylinder chamber. In FIG. 4 the volume of the air fuel mixture at top dead center is shown by numeral 11 (numeral 11 is the densely hatched area between cylinder head and the piston). Comparing FIGS. 4 & 3, one can see that the volume represented by numeral 11 in FIG. 4 is smaller than that of numeral 10 in FIG. 3. As a result the compression ratio of apparatus shown in FIG. 4 is higher than that of FIG. 3. It is obvious that the lengths of all the strokes for both apparatuses in these two figures are the same and the volume of the space that the compression ratio insert 9 will take is relatively insignificant compare to that of the intake volume. However the volume of compression ratio insert 9 is significant compare to the volume of the gas air mixture at top dead center position (that is numerals 10 or 11) and that is the reason that the change in the compression ratio occurs as the compression ratio insert 9 is pushed into or pulled out of cylinder chamber. It must also be noted that the sealing between the compression ratio insert 9 and head of cylinder 7 must be tight so that no substantial compressed gas can escape out of the cylinder chamber.

It is not the intention of this invention to address the methods of moving the compression ratio insert 9 into and out of the cylinder chamber; that might be achieved by mechanical, hydraulic or electrical servo motor mechanisms with appropriate controls. Nor is the intention of the invention to suggest any means or methods of control of the said action as to how often it must happen or for how long the insert 9 must stay at a certain position. It is primarily the methodology of changing the compression ratio which is under consideration.

In the figures shown in this disclosure, in each figure some parts might have not been shown and/or numbered; this is because only the concepts under consideration were to be addressed. As a result a detailed presentation of the internal combustion engine in these figures was avoided since it was not necessary.

The description given in this disclosure, it is obvious that the same may be varied in many other similar ways and methods. Such variations are not to be considered as departure from the core philosophy of the invented mechanisms. All such variations and modifications which are obvious to those skilled in the art are considered to be within the scope of this disclosure and embodied in the claims made.

What is claimed is:

1. An apparatus for substantial reduction of friction force between piston and cylinder for an internal combustion engine by supporting the piston rod with stationary roller or ball bearings, such that no significant force being exerted by the piston to the cylinder in the direction perpendicular to cylinder central axis; the said apparatus is comprised of at least an engine block with a cylinder, a piston, a piston rod with only one degree of freedom, at least four stationary roller or ball bearings, a stationary wall support and a crank cam used for cam engines;
the piston is slidable inside the said cylinder and has only one degree of freedom and that motion is translation along the central axis of the said cylinder;
the piston rod is connected to the said piston from one end and is connected to the crank cam of the cam engine from the opposite end and the said piston rod has only one degree of freedom and that motion is translation along the central axis of the said cylinder and no point of the said piston rod has any type of significant motion with respect to the said piston such that the piston and the piston rod could possibly, but not necessarily, be one solid piece; the connection of the piston rod to the crank cam is by any type of connecting mechanism normally used for reciprocation of linear motion to rotational motion for such cam engines;
the stationary wall support is fastened to the engine block by appropriate fasteners and the said stationary wall support holds the roller or ball bearings; the fastening of the said stationary wall support to the engine block could possibly but not necessarily be an adjustable fastening to allow minor adjustments of the said stationary wall support with respect to the engine block;
the piston rod is slidable between the said bearings such that as the piston rod moves in either of the two directions along the direction of the central axis of the cylinder, the outer case (cup) of each of the said bearings, as a result of close contact with the piston rod rotates; the central axes of said roller or ball bearings are stationary and only the outer case (cup) and the balls or rollers of each of the said bearings have motion; the outer case (cup) of each of the said bearings has close contact with the piston rod; the central axis of the said bearings is perpendicular to the central axis of the cylinder but not co-planer; on either side of the piston rod there are at least two of the said bearings such that the large force exerted by the crank cam to the piston rod, the component of the said force perpendicular to the cylinder axis, is absorbed by the said bearings such that no or no significant force is exerted by the piston rod to the piston and consequently no or no significant force in the said direction is exerted by the piston to the cylinder;
furthermore for reducing the size of the said bearings and to reduce the force exerted by the piston rod to the bearing to half of the original force, instead of each roller or ball bearing, the same concept of supporting of the piston rod could be accomplished by using two smaller stationary bearings for each larger bearing; the central axes of the said two smaller bearings are collinear and a shaft is supported by the said two smaller bearings and the said shaft is in close contact with the piston rod and the piston rod exerts the previously mention large force to the said shaft.

2. An apparatus as per claim 1 where the stationary roller or ball bearings are removed and instead moving cylindrical rollers are replaced and said moving cylindrical rollers are held between the piston rod and the stationary wall support such that the component of the large force exerted by the crank cam to the piston rod which is perpendicular to the cylinder central axis, is exerted to the said moving cylindrical rollers and from the said moving cylindrical rollers is exerted to the stationary wall support; and as the piston rod moves along the direction of the cylinder central axis, the said moving cylindrical rollers also translate and rotate with the piston rod in the same direction and preferably there must not be and slippage between the surfaces of the piston rod and the moving cylindrical rollers and the stationary wall support which are in contact; furthermore a minimum of two moving cylindrical rollers are needed on either side of the piston rod.

3. An apparatus as per claim 2 where the said moving cylindrical rollers and the corresponding sides of the piston rod and/or the corresponding surface of the stationary wall support which are in contact with the said moving cylindrical rollers are furnished with gear teeth and by having the said gears in mesh during the operation of the engine and motion of the piston rod, the slippage of the said moving cylindrical rollers on the surfaces of the piston rod and the stationary wall support is eliminated.

4. An apparatus as per claim 1 or 2 or 3 where the crank cam for the cam engine is removed and replaced with an ordinary crankshaft and the said ordinary crankshaft and the piston rod which has one degree of motion and that motion being translation in the direction of the cylinder central axis, are connected by a link; the said link functioning like an ordinary piston rod, from one end is connected to the ordinary crankshaft as the way a normal piston rod is connected to an ordinary crankshaft and from the opposite end the said link is connected to the end of the piston rod with one degree of motion the same way a piston rod is connected to a piston; that is said link with respect to the piston rod has only one degree of motion and that is rotation about pivot point at that point of connection of the said link to the piston rod with one degree of motion.

5. An apparatus for changing the compression ratio of an internal combustion engine; the apparatus at least comprising a head cylinder with an opening for an insert, an insert slidable inside the said opening of the said head cylinder, an operating mechanism to move the said insert into or out of the said head cylinder opening and appropriate controls to coordinate the movement of the said insert;
the said insert has the capability of being pushed into or pulled out of the said head cylinder by means of an operating mechanical or hydraulic or electric servo motor or other type of mechanism; and the said motion of the said insert into or out of the head cylinder by the said operating mechanism is controlled by electronic control unit to address the thermodynamics needs of the engine;
the said insert although slidable inside the opening of the said head cylinder, has a tight seal with the said opening in the head cylinder such that when the combustion chamber of the cylinder during ignition experiences extreme pressures, no or no significant amount of pressurized gas leaks outside the cylinder chamber through the said insert or the interface of the said insert and the said opening in the head cylinder; the volume of the said insert may not be significant relative to the volume of the cylinder but its volume is significant relative to the volume of the combustion chamber at top dead center position of the piston; thus, the said insert as pushed into the head cylinder reduces the volume of the cylinder chamber at the top dead center position of the piston and as a result increases the compression ratio and conversely as pulled out of the head cylinder increases the volume of the same and as a result decreasing the compression ratio of the combustion engine.

6. An apparatus for connecting a piston to a piston rod for an internal combustion engine where the said piston rod has only one degree of motion and that motion being translation along the central axis of the cylinder; the said connection does not allow the normal minute rotational motion of the piston with respect to the cylinder about the central axis of the normal connection point between the piston and the piston rod, but allows the piston to have minute translational motion with respect to the piston rod and the cylinder in any direction perpendicular to the axis of cylinder or that of the piston or the central axis of the piston rod; the apparatus at least is comprised of a piston, a piston and a cylinder;
the piston rod could possibly be supported by a support mechanism to restrict its motion to only translation along the central axis of the cylinder; the said piston rod is connected from one end to a cam shaft or an ordinary crankshaft by means of any type of reciprocating mechanism or link, and is connected from its opposite end to the piston, and at this said opposite end connection to the piston, the piston rod has a shape like the flat end of a nail and has a disk with two flat surfaces; said two surfaces are perpendicular to the central axis of the piston;
the piston at the location of connection to the piston rod has a slot, the said slot has two surfaces;
both of the said surfaces are perpendicular to the central axis of the piston; the gap between the said two surfaces accommodates the disk end of the piston rod; such that the disk end of the piston rod can slip in place between the said two surfaces of the piston; and during the operation of the engine the piston does not have any motion with respect to the piston rod in the direction of the piston central axis; but the piston can slide on the disk end of the piston rod and move in any direction perpendicular to the piston central axis.
